(19) United States
(12) Patent Application Publication
(10) Pub. No.: US 2026/0051036 A1
(43) Pub. Date: Feb. 19, 2026

(54) VIDEO PROCESSING SYSTEM, VIDEO PROCESSING APPARATUS, AND VIDEO PROCESSING METHOD

(71) Applicant: NEC Corporation, Minato-ku, Tokyo (JP)

(72) Inventors: Hayato ITSUMI, Tokyo (JP); Koichi NIHEI, Tokyo (JP); Florian BEYE, Tokyo (JP); Katsuhiko TAKAHASHI, Tokyo (JP); Yasunori BABAZAKI, Tokyo (JP); Ryuhei ANDO, Tokyo (JP); Jun PIAO, Tokyo (JP)

(73) Assignee: NEC Corporation, Minato-ku, Tokyo (JP)

(21) Appl. No.: 19/103,620

(22) PCT Filed: Aug. 31, 2022
(86) PCT No.: PCT/JP2022/032763

§ 371 Date: Feb. 13, 2025

(51) Int. Cl. G06T 7/00; G06V 10/74; G06V 20/52

(52) U.S. Cl. CPC G06T 7/0002; G06V 10/761; G06V 20/52; G06T 2207/30168; G06V 2201/07

(57) ABSTRACT

A video processing system (10) includes an object detection unit (11) that detects an object included in a video input to the video processing system (10) in a case where the video is input to the video processing system (10). The video processing system (10) further includes a video quality control unit (12) that controls a video quality of a region including the object in the input video according to a situation related to the object detected from the input video in a case where the object detection unit (11) detects the object from the input video.

### TECHNICAL FIELD

The present disclosure relates to a video processing system, a video processing apparatus, and a video processing method.

### Background Art

Technologies for distributing a video via a network have been developed. Patent Literature 1 is known as a related technology. Patent Literature 1 describes a technology for encoding a region in a video specified based on a person or an object registered in a database so as to have a higher image quality than the other region in a video processing apparatus that transmits a video.

### CITATION LIST

### Patent Literature

Patent Literature 1: International Patent Publication No. WO2018/037890

### SUMMARY OF INVENTION

### Technical Problem

As described above, in the related technology such as Patent Literature 1, a region including an object registered in advance in a database is set as an image quality improvement region. However, in the related technology, since the image quality of the region including the registered object is always improved, a quality of the video cannot be appropriately controlled according to various situations. For example, in a case where there is a plurality of objects that are targets of image quality improvement in the video, it may be difficult to transmit the video in which the image qualities of all the regions including the target objects are improved.

In view of such a problem, an object of the present disclosure is to provide a video processing system, a video processing apparatus, and a video processing method capable of suitably controlling a quality of a video.

### Solution to Problem

A video processing system according to the present disclosure includes: object detection means for detecting an object included in an input video; and video quality control means for controlling a video quality of a region including the object in the video according to a situation related to the detected object.

A video processing apparatus according to the present disclosure includes: object detection means for detecting an object included in an input video; and video quality control means for controlling a video quality of a region including the object in the video according to a situation related to the detected object.

A video processing method according to the present disclosure includes: detecting an object included in an input video; and controlling a video quality of a region including the object in the video according to a situation related to the detected object.

### Advantageous Effects of Invention

According to the present disclosure, it is possible to provide a video processing system, a video processing apparatus, and a video processing method capable of suitably controlling a quality of a video.

### BRIEF DESCRIPTION OF DRAWINGS

FIG. 1 is a configuration diagram illustrating an outline of a video processing system according to an example embodiment.

FIG. 2 is a configuration diagram illustrating an outline of a video processing apparatus according to the example embodiment.

FIG. 3 is a flowchart illustrating an outline of a video processing method according to the example embodiment.

FIG. 4 is a diagram for describing the video processing method according to the example embodiment.

FIG. 5 is a configuration diagram illustrating a basic configuration of a remote monitoring system according to the example embodiment.

FIG. 6 is a configuration diagram illustrating a configuration example of a remote monitoring system according to a first example embodiment.

FIG. 7 is a diagram illustrating an example of a related object association table according to the first example embodiment.

FIG. 8 is a diagram illustrating another example of the related object association table according to the first example embodiment.

FIG. 9 is a flowchart illustrating an operation example of the remote monitoring system according to the first example embodiment.

FIG. 10 is a diagram for describing video acquisition processing according to the first example embodiment.

FIG. 11 is a diagram for describing object detection processing according to the first example embodiment.

FIG. 12 is a diagram for describing relationship analysis processing according to the first example embodiment.

FIG. 13 is a diagram for describing the relationship analysis processing according to the first example embodiment.

FIG. 14 is a diagram for describing the relationship analysis processing according to the first example embodiment.

FIG. 15 is a diagram for describing sharpening region determination processing according to the first example embodiment.

FIG. 16 is a configuration diagram illustrating a configuration example of a remote monitoring system according to a second example embodiment.

FIG. 17 is a diagram illustrating an example of a work-object association table according to the second example embodiment.

FIG. 18 is a diagram illustrating another example of the work-object association table according to the second example embodiment.

FIG. 19 is a configuration diagram illustrating a configuration example of a remote monitoring system according to a third example embodiment.

FIG. 20 is a diagram illustrating an example of a work-related object association table according to the third example embodiment.

FIG. 21 is a diagram illustrating another example of the work-related object association table according to the third example embodiment.

FIG. 22 is a configuration diagram illustrating a configuration example of a remote monitoring system according to a fourth example embodiment.

FIG. 23 is a diagram for describing frame rate control processing according to the fourth example embodiment.

FIG. 24 is a configuration diagram illustrating an outline of hardware of a computer according to the example embodiment.

### EXAMPLE EMBODIMENT

Hereinafter, example embodiments will be described with reference to the drawings. In the drawings, the same elements are denoted by the same reference signs, and redundant description will be omitted as necessary.

### Outline of Example Embodiment

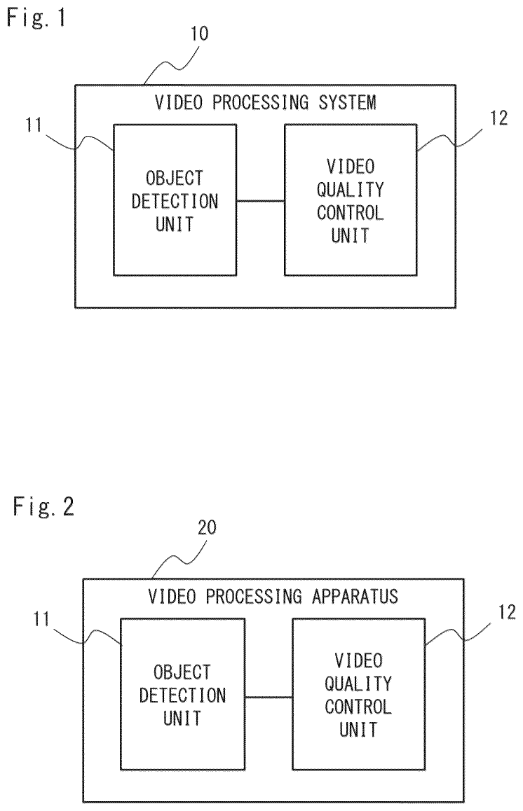

First, an outline of an example embodiment will be described. FIG. 1 illustrates a schematic configuration of a video processing system 10 according to the example embodiment. The video processing system 10 is applicable to, for example, a remote monitoring system that distributes a video via a network and recognizes the distributed video.

As illustrated in FIG. 1, the video processing system 10 includes an object detection unit 11 and a video quality control unit 12. The object detection unit 11 detects an object included in an input video. Detecting the object includes specifying a type of the object included in the video. For example, the object may be specified as a person, a specific device such as a compactor, or a specific worker as the type of the object, and for example, the object in the video may include a plurality of objects, and may include a person who performs work as a first object and a work object used by a person in work as a second object. The first object is not limited to the person and may be any object, and the second object is not limited to the work object and may be any object.

The video quality control unit 12 controls a video quality of a region including the object in the video according to a situation related to the detected object. The situation related to the object may include a relationship such as a positional relationship between the first object and the second object. The video quality control unit 12 may control the video quality of the region including the first object and the second object according to the positional relationship between the first object and the second object. The positional relationship is, for example, a distance between the first object and the second object, an overlap between a region related to detection of the first object and a region related to detection of the second object, or the like. The region related to the detection of the object is a rectangular region including the object extracted in a case where the object is detected from an image, that is, a bounding box or the like. The situation related to the object may also include a situation of the work performed using the work object. The video quality control unit 12 may control the video quality of the region including the detected object according to whether or not the detected object is the work object corresponding to the situation of the work. For example, the situation of the work is the currently performed work, a work process, or the like. The video quality control unit 12 may control an image quality of the video or may control a frame rate of the video as control of the video quality. For example, the image quality of the region including the detected object may be improved to be higher than those of other regions. The image quality improvement is to sharpen the image, and to make the image quality of the region including the detected object higher than the image qualities of other regions. The image quality of the region including the object may be improved by making the image qualities of other regions lower than the image quality of the region including the object. For example, in a case of lowering the image quality of a specific region, a compression rate of the specific region may be increased. Furthermore, the region including the object may have a higher frame rate than those of other regions. The frame rate of the region including the object may be increased by decreasing frame rates of other regions to be lower than the frame rate of the region including the object. In a case of decreasing the frame rate of the specific region, the frame rate may be substantially decreased by copying the images of the specific regions in previous and subsequent frames at an interval corresponding to the frame rate.

Note that the video processing system 10 may be configured by one apparatus or a plurality of apparatuses. FIG. 2 illustrates a configuration of a video processing apparatus 20 according to the example embodiment. As illustrated in FIG. 2, the video processing apparatus 20 may include the object detection unit 11 and the video quality control unit 12 illustrated in FIG. 1. In addition, a part of or the entirety of the video processing system 10 may be disposed on an edge or a cloud. For example, the object detection unit 11 and the video quality control unit 12 may be arranged in a terminal of the edge.

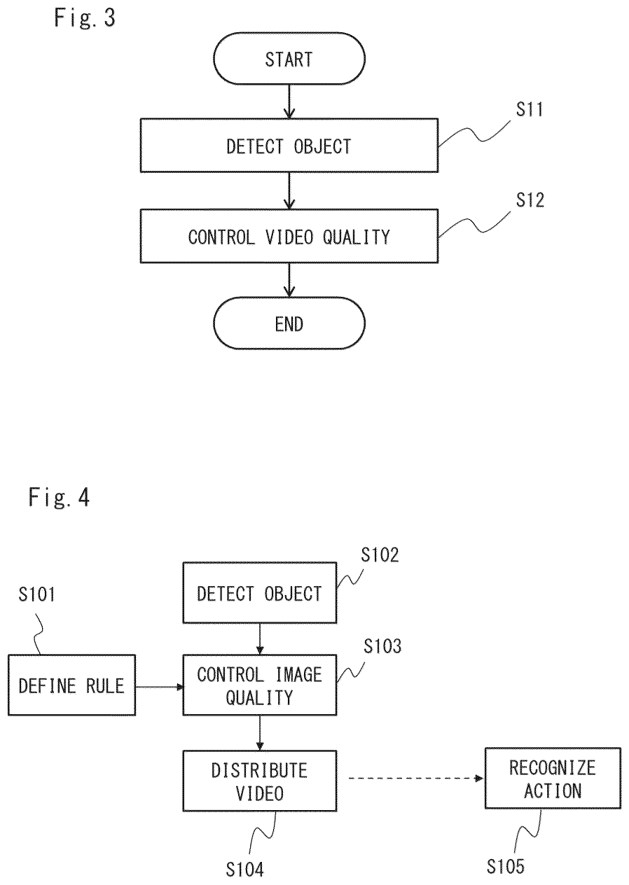

FIG. 3 illustrates a video processing method according to the example embodiment. For example, the video processing method according to the example embodiment is performed by the video processing system 10 or the video processing apparatus 20 of FIGS. 1 and 2. As illustrated in FIG. 3, first, the object detection unit 11 detects an object included in an input video (S11). Next, the video quality control unit 12 controls the video quality of the region including the object in the video according to the situation related to the detected object (S12). The video quality control unit 12 may control the video quality of the region including the object according to a change in the relationship such as the positional relationship between the objects. Furthermore, the video quality control unit 12 may assign an importance to the region of the object according to the situation related to the object, and control the video quality of the region including the object based on the assigned importance. For example, the importance may be assigned to the region of the object according to the positional relationship between the objects, or the importance may be assigned to the region of the object corresponding to the work. For example, the quality of each region may be improved in descending order of importance.

Here, an example in which a video is distributed from the terminal of the edge to a server of the cloud via the network, and the server recognizes the video will be considered. In a system in which a camera video is transmitted from the terminal via the network and the video is recognized by the server, a bit rate of the video to be transmitted may be reduced because a band available for video transmission is limited due to a communication environment of the network, or the bit rate of the video to be transmitted may be reduced to reduce a load of the network. If the image quality of the entire video is lowered according to the reduction in the bit rate, it is difficult for the server to recognize the video with the lowered image quality, and thus, recognition accuracy decreases. The recognition of the video is recognition regarding a target included in the video, and includes, for example, recognition of the object including the person, recognition of an action of the person, recognition of a state of the object, and the like. Furthermore, as a method of reducing the bit rate, a method of improving the image quality of the region including a predetermined object and lowering the image quality of the other region can be considered. By improving the image quality of the region including the person or the object recognized by the server, it is possible to suppress deterioration in recognition accuracy to some extent even in a case of reducing the bit rate. However, it may be difficult to reduce the bit rate in a case where there are many regions in which the image quality is desired to be improved. For example, in a case where a large number of people appear in the video, or in a case where the object that is a recognition target occupies most of a screen, the bit rate cannot be reduced because the image quality of most of the region is improved. Therefore, in the example embodiment, it is possible to secure necessary recognition accuracy while reducing the bit rate.

FIG. 4 illustrates an operation example in a case where the video is distributed from the terminal to the server in the video processing method according to the example embodiment. For example, the video processing system that performs the video processing method of FIG. 4 may further include a video distribution unit and an action recognition unit in addition to the configuration of FIG. 1 in order to distribute the video and recognize the action from the distributed video. For example, the terminal may include the object detection unit, the video quality control unit, and the video distribution unit, and the server may include the action recognition unit.

As illustrated in FIG. 4, in the video processing method according to the example embodiment, a rule is defined in the terminal in advance (S101). For example, a table in which the first object and the second object are associated with each other, a table in which the work and the object are associated with each other, or the like may be stored as the rule. In addition, a rule for assigning the importance according to the situation related to the object may be defined.

Next, the object detection unit detects the object from the camera video (S102), and the video quality control unit controls the image quality of the video according to the defined rule (S103). The video quality control unit may improve the image quality of the region including the first object and the second object in a predetermined positional relationship according to the rule. In addition, the video quality control unit may improve the image quality of the region including the object corresponding to the work according to the rule. For example, in a case where a distance between a construction machine and the worker is small, the video quality control unit may prioritize a person close to the construction machine among a number of people to improve the image quality by assigning a high importance. For example, by assigning a high importance to a worker who holds a tool, the image quality of the worker may be improved in preference to that of a worker who does not hold the tool. Next, the video distribution unit distributes the video in which the image quality is controlled (S104), and the action recognition unit recognizes the action of the person from the distributed video (S105). The action recognition unit is not limited to the recognition of the action of the person, and may recognize the state of the object or the like. The state of the object is, for example, an operation state of a robot that autonomously moves, an operation state of a heavy machine, or the like.

As described above, in the example embodiment, the video quality of the region including the object is controlled according to the situation related to the object detected in the video. As a result, the quality of the video can be appropriately controlled according to the situation related to the object. For example, the region including the object may be controlled to have a high quality based on the positional relationship between the objects or the situation of the work or the like. As a result, in a case where there is a plurality of regions in which the quality is desired to be improved, it is possible to further narrow down the regions in which the quality is desired to be improved based on the rule.

Therefore, it is possible to secure necessary recognition accuracy while reducing the bit rate.

### Basic Configuration of Remote Monitoring System

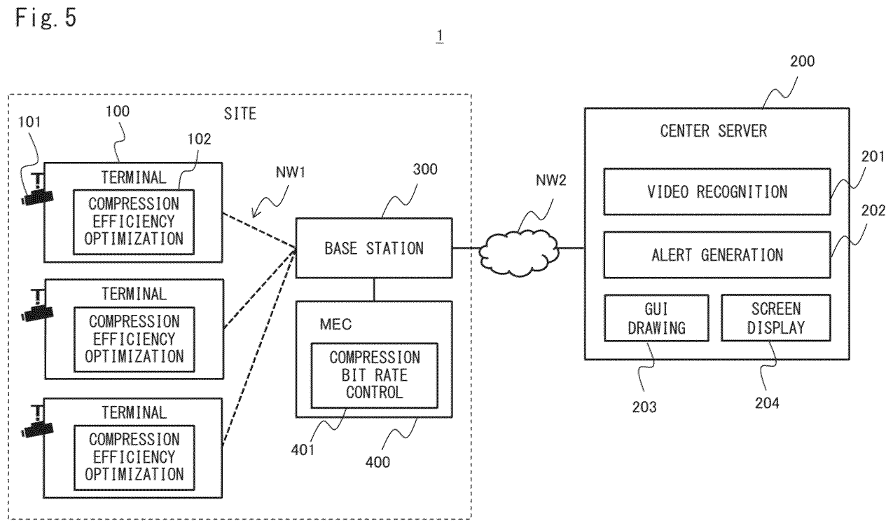

Next, the remote monitoring system that is an example of a system to which the example embodiment is applied will be described. FIG. 5 illustrates a basic configuration of a remote monitoring system 1. The remote monitoring system 1 is a system that monitors a captured area by a video captured by a camera. The present example embodiment will be described below as a system that remotely monitors work of a worker in a site. For example, the site may be an area where people and machines operate, such as a work site or a factory, for example, a construction site, a square where people gather, a station, or a school. In the present example embodiment, the work will be described below as construction work, civil engineering work, or the like, but the work is not limited thereto. Note that the video includes a plurality of time-series images (also referred to as frames), and thus the terms video and image can be used interchangeably. That is, the remote monitoring system can be said to be a video processing system that processes a video or an image processing system that processes an image.

As illustrated in FIG. 5, the remote monitoring system 1 includes a plurality of terminals 100, a center server 200, a base station 300, and a multi-access edge computing (MEC) 400. The terminal 100, the base station 300, and the MEC 400 are disposed on a site side, and the center server 200 is disposed on a center side. For example, the center server 200 is disposed in a data center or the like disposed at a position away from the site. The site side is also referred to as an edge side of the system, and the center side is also referred to as a cloud side.

The terminal 100 and the base station 300 are communicably connected by a network NW1. The network NW1 is, for example, a wireless network such as 4G, local 5G/5G, long term evolution (LTE), or wireless LAN. Note that the network NW1 is not limited to a wireless network, and may be a wired network. The base station 300 and the center server 200 are communicably connected by a network NW2. The network NW2 includes, for example, a core network such as a 5th Generation Core network (5GC) or an Evolved Packet Core (EPC), the Internet, and the like. Note that the network NW2 is not limited to a wired network, and may be a wireless network. It can also be said that the terminal 100 and the center server 200 are communicably connected via the base station 300. The base station 300 and the MEC 400 are communicably connected by an arbitrary communication method, but the base station 300 and the MEC 400 may be one apparatus.

The terminal 100 is a terminal apparatus connected to the network NW1, and is also a video distribution apparatus that distributes a video of the site. The terminal 100 acquires a video captured by a camera 101 installed at the site, and transmits the acquired video to the center server 200 via the base station 300. Note that the camera 101 may be disposed outside the terminal 100 or inside the terminal 100.

The terminal 100 compresses the video of the camera 101 to a predetermined bit rate, and transmits the compressed video. The terminal 100 has a compression efficiency optimization function 102 for optimizing compression efficiency. The compression efficiency optimization function 102 performs region of interest (ROI) control for controlling an image quality of an ROI in the video. The ROI is a predetermined region in the video. The ROI may be a region including a recognition target of the video recognition function 201 of the center server 200, or may be a gaze region to be gazed by a user. The compression efficiency optimization function 102 reduces the bit rate by lowering an image quality of a region around the ROI including a person or an object while maintaining the image quality of the ROI. Furthermore, the terminal 100 may include the object detection unit that detects an object from the acquired video. The compression efficiency optimization function 102 may include the video quality control unit that controls the video quality of the region including the object in the video according to the situation related to the detected object.

The base station 300 is a base station apparatus of the network NW1, and is also a relay apparatus that relays communication between the terminal 100 and the center server 200. For example, the base station 300 is a local 5G base station, a 5G next generation node B (gNB), an LTE evolved node B (eNB), an access point of a wireless LAN, or the like, and may be another relay apparatus.

The multi-access edge computing (MEC) 400 is an edge processing apparatus disposed on the edge side of the system. The MEC 400 is an edge server that controls the terminal 100, and has a compression bit rate control function 401 for controlling the bit rate of the terminal. The compression bit rate control function 401 controls the bit rate of the terminal 100 by adaptive video distribution control or quality of experience (QoE) control. The adaptive video distribution control controls a bit rate or the like of a video to be distributed according to the situation of the network. For example, the compression bit rate control function 401 predicts the recognition accuracy obtained in a case where the video is input to the recognition model by suppressing the bit rate of the distributed video, according to a communication environment of the networks NW1 and NW2, and assigns the bit rate to the video distributed by the camera 101 of each terminal 100 so as to improve the recognition accuracy. Note that the control is not limited to the control of the bit rate, and a frame rate of the distributed video may be controlled according to the situation of the network.

The center server 200 is a server installed on the center side of the system. The center server 200 may be one or a plurality of physical servers, a cloud server constructed on the cloud, or other virtualization servers. The center server 200 is a monitoring apparatus that monitors work in a site by analyzing and recognizing a camera video of the site. The center server 200 is also a video reception apparatus that receives a video transmitted from the terminal 100.

The center server 200 has a video recognition function 201, an alert generation function 202, a graphical user interface (GUI) drawing function 203, and a screen display function 204. The video recognition function 201 inputs a video transmitted from the terminal 100 to a video recognition artificial intelligence (AI) engine, thereby recognizing work performed by a worker, that is, a type of an action of a person.

The alert generation function 202 generates an alert according to recognized work. The GUI drawing function 203 displays a graphical user interface (GUI) on a screen of a display apparatus. The screen display function 204 displays a video, a recognition result, an alert, and the like of the terminal 100 on the GUI. Note that any of the functions may be omitted or any of the functions may be included as necessary. For example, the center server 200 does not have to include the alert generation function 202, the GUI drawing function 203, and the screen display function 204.

### First Example Embodiment

Next, a first example embodiment will be described. In the present example embodiment, an example in which a sharpening region is determined based on the relationship between the objects will be described.

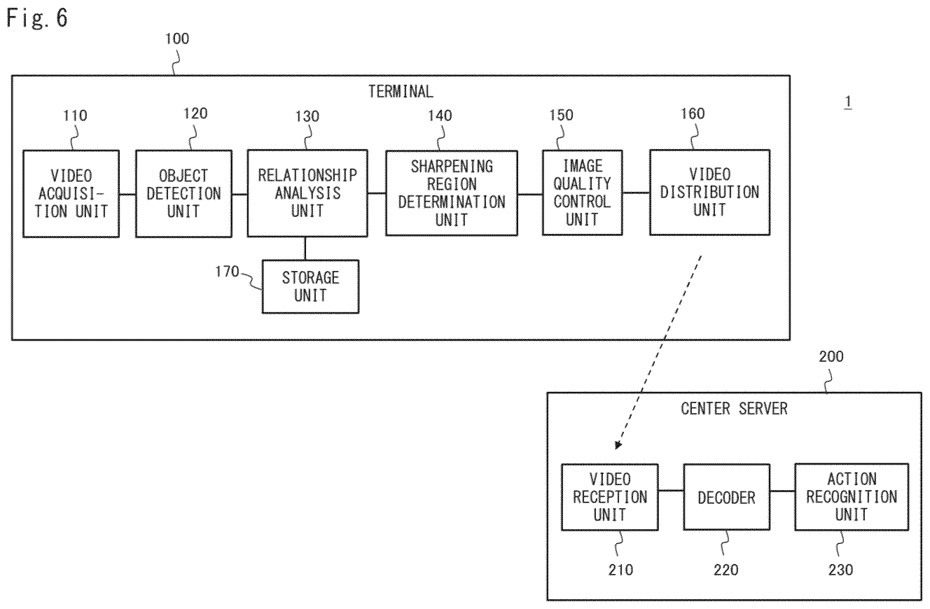

First, a configuration of the remote monitoring system according to the present example embodiment will be described. A basic configuration of the remote monitoring system 1 according to the present example embodiment is as illustrated in FIG. 5. FIG. 6 illustrates a configuration example of the remote monitoring system 1 according to the present example embodiment. Note that the configuration of each apparatus is an example, and another configuration may be used as long as an operation according to the present example embodiment described below can be performed. For example, some functions of the terminal 100 may be disposed in the center server 200 or another apparatus, or some functions of the center server 200 may be disposed in the terminal 100 or another apparatus. In addition, the functions of the MEC 400 having the compression bit rate control function may be disposed in the center server 200, the terminal 100, or the like.

As illustrated in FIG. 6, the terminal 100 includes a video acquisition unit 110, an object detection unit 120, a relationship analysis unit 130, a sharpening region determination unit 140, an image quality control unit 150, a video distribution unit 160, and a storage unit 170.

The video acquisition unit 110 acquires a video captured by the camera 101. The video captured by the camera is hereinafter also referred to as an input video. For example, the input video includes a person who is a worker who performs work in a site, a work object used by the person, and the like. The video acquisition unit 110 is also an image acquisition unit that acquires a plurality of time-series images, that is, frames.

The object detection unit 120 detects an object in the acquired input video. The object detection unit 120 detects the object in each image included in the input video and recognizes the type of the detected object. For example, the object detection unit 120 extracts a rectangular region including the object from each image included in the input video, and recognizes the type of the object in the extracted rectangular region. The rectangular region is a bounding box or an object region. Note that the object region including the object is not limited to the rectangular region, and may be a region having a circular or amorphous silhouette, or the like. The object detection unit 120 calculates a feature amount of an image of the object included in the rectangular region, and recognizes the object based on the calculated feature amount. For example, the object detection unit 120 recognizes the object in the image by an object recognition engine using machine learning such as deep learning. The object can be recognized by performing machine learning of a feature of the image of the object and the type of the object. A detection result of the object includes the object type, position information of the rectangular region including the object, and the like. The position information of the object is, for example, coordinates of each vertex of the rectangular region, and may be a position of the center of the rectangular region or a position of an arbitrary point of the object.

The relationship analysis unit 130 analyzes the relationship between the objects based on the detection result of the object detected in the input video. The relationship analysis unit 130 analyzes the relationship between the objects having a predetermined type among the detected objects. For example, the relationship between the first object and the second object associated in the related object association table stored in the storage unit 170 is analyzed. The relationship between the objects is a positional relationship such as a distance between the objects or an overlap between the regions of the objects, and includes a distance of position information assigned to each of the first object and the second object. In addition, the relationship between the objects may include orientations of the objects. The relationship analysis unit 130 may determine the presence or absence of the relationship between the objects based on the positional relationship between the objects or orientations of the objects, or may assign the importance to the region of the object according to the positional relationship between the objects or the orientations of the objects. That is, the relationship analysis unit 130 may be an importance determination unit that determines the importance. The importance is a degree to be preferentially recognized by the action recognition unit 230 of the center server 200, and indicates a priority for sharpening. For example, the importance may be assigned to the region of the object according to the importance set in the table stored in the storage unit 170. The importance may be assigned based only on a combination of the detected first and second objects.

The sharpening region determination unit 140 determines the sharpening region for enhancing the image quality in the acquired input video based on the analyzed relationship between the objects. For example, the sharpening region determination unit 140 may determine the regions of the first object and the second object determined to be relevant as the sharpening regions. In addition, the sharpening region determination unit 140 may determine the sharpening region according to the assigned importance of the region.

The image quality control unit 150 controls the image quality of the input video based on the determined sharpening region. The sharpening region is a region where the image quality is enhanced compared to other regions, that is, an image quality improvement region where the image quality is improved compared to other regions. The sharpening region is also the ROI. The image quality control unit 150 is an encoder that encodes the input video by a predetermined encoding method. The image quality control unit 150 performs encoding by a video encoding method such as H.264 or H.265, for example. The image quality control unit 150 compresses each of the sharpening region and other regions at a predetermined compression rate, that is, a bit rate, to perform encoding such that the image quality of the sharpening region becomes a predetermined quality.

That is, by changing the compression rates of the sharpening region and other regions, the image quality of the sharpening region is improved to be higher than those of other regions. It can also be said that the image quality of the other region is lowered to be lower than that of the sharpening region. For example, it is possible to lower the image quality by smoothing changes in pixel values between adjacent pixels. Note that the image quality of each region may be controlled according to the bit rate corresponding to the importance of each region. For example, the image quality may be changed between the sharpening regions having different importances.

The image quality control unit 150 may encode the input video at the bit rate assigned from the compression bit rate control function 401 of the MEC 400. The image qualities of the sharpening region and other regions may be controlled within a range of the assigned bit rate. In addition, the image quality control unit 150 may determine the bit rate based on a communication quality between the terminal 100 and the center server 200. The image qualities of the sharpening region and other regions may be controlled within a range of the bit rate based on the communication quality. The communication quality is, for example, a communication speed, and may be another indicator such as a transmission delay or an error rate. The terminal 100 may include a communication quality measurement unit that measures the communication quality. For example, the communication quality measurement unit determines the bit rate of the video to be transmitted from the terminal 100 to the center server 200 according to the communication speed. The communication speed may be measured based on a data amount received by the base station 300 or the center server 200, and the communication quality measurement unit may acquire the measured communication speed from the base station 300 or the center server 200. In addition, the communication quality measurement unit may estimate the communication speed based on the data amount per unit time transmitted from the video distribution unit 160.

The video distribution unit 160 distributes the video in which the image quality is controlled by the image quality control unit 150, that is, encoded data, via the network. The video distribution unit 160 transmits the encoded data to the center server 200 via the base station 300. The video distribution unit 160 is a communication interface capable of communicating with the base station 300, and is, for example, a wireless interface such as 4G, local 5G/5G, LTE, or a wireless LAN, but may be a wireless or wired interface of any other communication scheme.

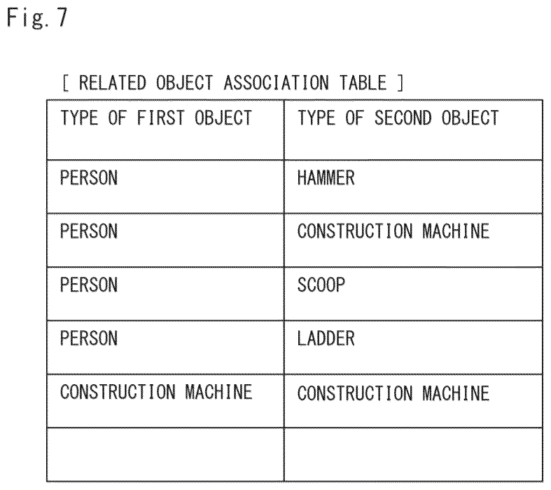

The storage unit 170 stores data necessary for processing in the terminal 100. A storage unit 170 stores a table for analyzing the relationship between the objects. Specifically, a related object association table in which a pair of related objects for analyzing the relationship is associated is stored. FIG. 7 illustrates a specific example of the related object association table. As illustrated in FIG. 7, in the related object association table, a type of the first object and a type of the second object are associated with each other as the related objects whose relationship is analyzed. In this example, a hammer, a construction machine, a scoop, and a ladder are associated with each person, and the construction machine and the construction machine are associated with each other. For example, the related object association table may define a pair of objects corresponding to recognition targets recognized from a video by the center server 200. In a case where the center server 200 recognizes work performed by the person, a work object used for the work, for example, the hammer or the scoop, is associated with the person who performs the work. In this case, one of the first object and the second object is the person, and the other is the work object. In a case of recognizing work performed by two construction machines, a first construction machine and a second construction machine are associated with each other. In this case, the first object and the second object are the work objects. In addition, in a case of recognizing an unsafe action in which the person is in a dangerous state, the object that induces the unsafe action, for example, the construction machine, the ladder, or the like, is associated with the person. In this case, one of the first object and the second object becomes the person, and the other becomes the object that induces the unsafe action.

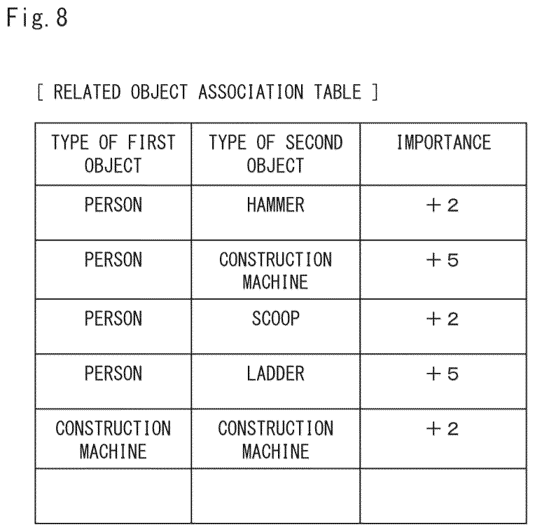

FIG. 8 illustrates another example of the related object association table. As illustrated in FIG. 8, in the related object association table, the assigned importance may be associated with the related objects to be analyzed, that is, the pair of the first object and the second object. For example, the importance may be set according to the recognition target recognized from the video by the center server 200. The importance of a pair of the person and the construction machine or a pair of the person and the ladder related to the unsafe action may be set higher than that of a pair of the person and the hammer or a pair of the person and the scoop related to the work. For example, an importance of +5 is assigned to a region of the person close to the construction machine or a region of the person overlapping the construction machine, and an importance of +2 is assigned to a region of the person close to the hammer or a region of the person overlapping the hammer. The importance of +5 may be assigned to the region of the person based only on a combination of the person and the construction machine, and the importance of +2 may be assigned to the region of the person based only on a combination of the person and the hammer. Note that the importance is not limited to a numerical value, and may be a level such as high, medium, or low.

Furthermore, as illustrated in FIG. 6, the center server 200 includes a video reception unit 210, a decoder 220, and an action recognition unit 230.

The video reception unit 210 receives the video after the image quality control transmitted from the terminal 100, that is, the encoded data, via the base station 300. The video reception unit 210 receives the input video acquired and distributed by the terminal 100 via the network. The video reception unit 210 is a communication interface capable of communicating with the Internet or a core network, and is, for example, a wired interface for IP communication, but may be a wired or wireless interface of any other communication scheme.

The decoder 220 decodes the encoded data received from the terminal 100. The decoder 220 is a decoding unit that decodes the encoded data. The decoder 220 is also a restoration unit that restores the encoded data, that is, compressed data, by a predetermined encoding method. The decoder 220 supports an encoding method of the terminal 100, and performs decoding by a moving image encoding method such as H.264 or H.265. The decoder 220 decodes the video according to the compression rate or the bit rate of each region, and generates a decoded video. The decoded video is hereinafter also referred to as a reception video.

The action recognition unit 230 analyzes the reception video, and recognizes the action of the object in the reception video. For example, work performed by a person using the object, an unsafe action in which the person is in a dangerous state, and the like are recognized. Note that not only the action recognition but also other video recognition processing may be performed. The action recognition unit 230 detects the object from the reception video, recognizes the action or the state of the detected object, and outputs the recognition result. For example, the action recognition unit 230 may perform action recognition by an action recognition engine using machine learning such as deep learning. It is possible to recognize an action of a person in a video by performing machine learning of the feature and the action type of the video of the person performing work. For example, the action recognition unit 230 is a learning model that can perform learning and prediction based on time-series video data, and may be a convolutional neural network (CNN) or a recurrent neural network (RNN), or may be another neural network, for example. Note that the action of the object may be recognized not only based on machine learning but also based on a predetermined rule. For example, the work object used by the person and the work may be associated with each other, and the work may be recognized from the detected object. For example, a work content may be associated with a pair of objects defined similarly to the related object association table of the storage unit 170 of the terminal 100.

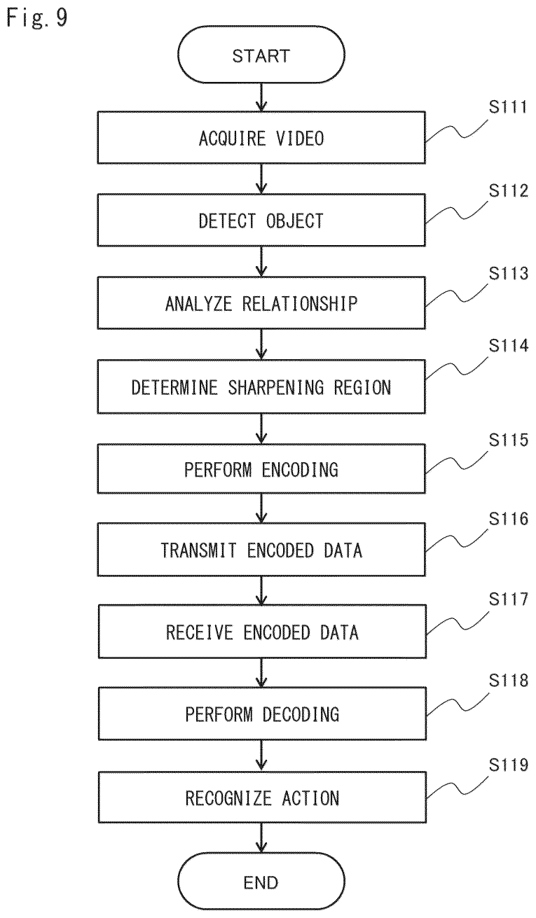

Next, an operation of the remote monitoring system according to the present example embodiment will be described. FIG. 9 illustrates an operation example of the remote monitoring system 1 according to the present example embodiment. For example, it is described that the terminal 100 executes S111 to S116 and the center server 200 executes S117 to S119, but the present example embodiment is not limited thereto, and any apparatus may execute each process.

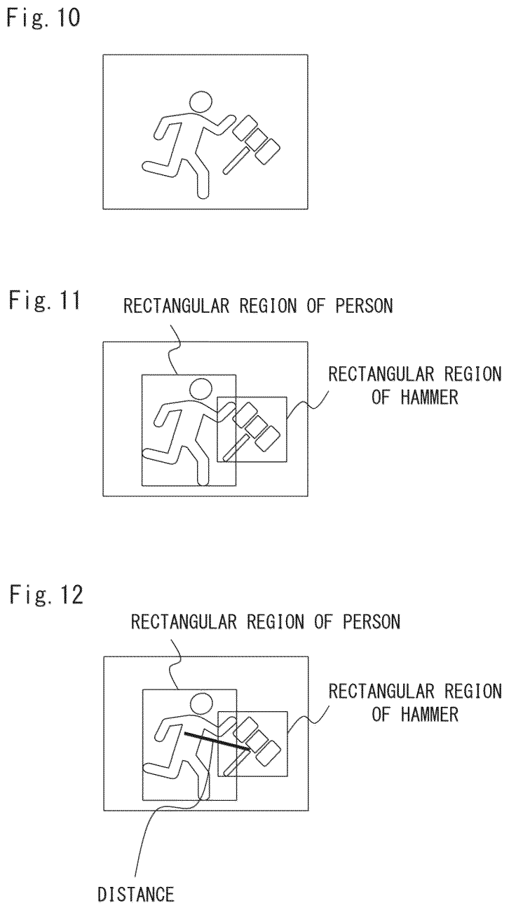

As illustrated in FIG. 9, the terminal 100 acquires the video from the camera 101 (S111). The camera 101 generates the video obtained by capturing the site, and the video acquisition unit 110 acquires the video, that is, the input video output from the camera 101. For example, as illustrated in FIG. 10, the image of the input video includes the person who performs the work in the site and the work object such as the hammer used by the person.

Subsequently, the terminal 100 detects an object based on the acquired input video (S112). The object detection unit 120 detects the rectangular region in the image included in the input video by using the object recognition engine, and recognizes the type of the object in the detected rectangular region. For each detected object, the object detection unit 120 outputs the object type and the position information of the rectangular region of the object as the object detection result. For example, in a case where object detection is performed from the image of FIG. 10, the person and the hammer are detected, and the rectangular region of the person and the rectangular region of the hammer are detected as illustrated in FIG. 11.

Subsequently, the terminal 100 analyzes the relationship between the detected objects based on the object detection result (S113). The relationship analysis unit 130 extracts the first object and the second object having the type of the object associated in the related object association table from among the detected objects by referring to the related object association table of the storage unit 170, and analyzes the positional relationship between the extracted first object and second object and the orientations of the extracted first object and second object. In the example of FIG. 11, the person and the hammer associated in the related object association table of FIG. 7 are extracted from the image, and the positional relationship between the person and the hammer and the orientations of the person and the hammer are analyzed.

FIG. 12 illustrates an example of analyzing the distance between the objects from the object detection result of FIG. 11. For example, the distance between the objects is a distance between the object regions that are the rectangular regions including the detected objects. In the example of FIG. 12, a distance between a center point of the rectangular region of the detected person and a center point of the rectangular region of the detected hammer is obtained. Note that the distance is not limited to the distance between the center points of the rectangular regions, and may be a distance between any vertexes of the rectangles or a distance between other arbitrary points. For example, in a case where the obtained distance is smaller than a predetermined threshold, the relationship analysis unit 130 determines that the person as the first object and the hammer as the second object are relevant. The threshold used in the determination may be set for each pair of the first object and the second object in the related object association table.

In addition, in a case where the importance is assigned according to the distance between the objects, the importance set in the related object association table is assigned according to the obtained distance between the objects. For example, in a case where the distance between the person and the hammer is smaller than the threshold, an importance of +2 is assigned to the regions of the person and the hammer by referring to the related object association table of FIG. 8. Note that the importance to be assigned may be increased as the distance decreases.

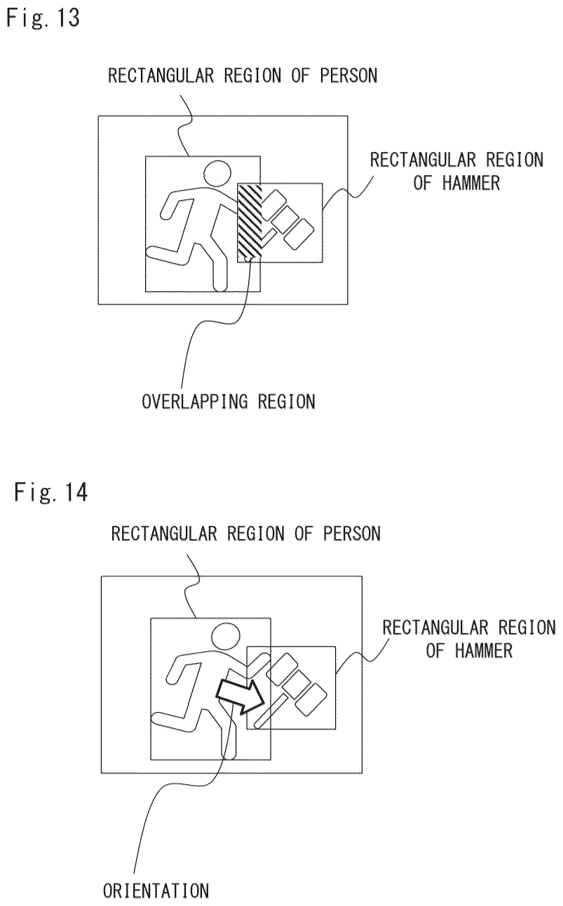

FIG. 13 illustrates an example of analyzing the overlap between the objects from the object detection result of FIG. 11. The overlap between the objects is an overlap between the object regions which are the rectangular regions including the detected objects, and is indicated by, for example, intersection over union (IoU). In the example of FIG. 13, a size of the rectangular region of the detected person, a size of the rectangular region of the detected hammer, and a size of an overlapping region between the rectangular regions are obtained, and a ratio of the overlapping region with respect to the rectangular regions of the two objects is obtained. Note that the ratio of the overlapping region with respect to the rectangular region of any object may be obtained, or only the overlapping region may be obtained. For example, in a case where the obtained overlap is larger than a predetermined threshold, the relationship analysis unit 130 determines that the person as the first object and the hammer as the second object are relevant.

The threshold used in the determination may be set for each pair of the first object and the second object in the related object association table.

In addition, in a case where the importance is assigned according to the overlap between the objects, the importance set in the related object association table is assigned according to the obtained overlap between the objects. For example, in a case where the overlap between the person and the hammer is larger than the threshold, an importance of +2 is assigned to the regions of the person and the hammer by referring to the related object association table of FIG. 8.

Note that the importance to be assigned may be increased as the overlap increases.

FIG. 14 illustrates an example of analyzing the orientation of the object from the object detection result of FIG. 11. For example, the orientation of the object indicates a direction extending forward from the object. The orientations of both of the two objects may be extracted, or the orientation of one of the two objects may be extracted. In the example of FIG. 14, the orientation of the detected person is extracted. The orientation of the person may be extracted by estimating a skeleton and pose of the person from the detection result of the object, or the orientation of the person may be extracted from the detected orientation of the face of the person.

For example, in order to determine whether or not the extracted person is orientated toward the hammer, the relationship analysis unit 130 may obtain an angle of the extracted orientation with respect to a line connecting the center point of the rectangular region of the person and the center point of the rectangular region of the hammer. In a case where the obtained angle of the orientation is smaller than a threshold, it may be determined that the person and the hammer are relevant. The threshold used in the determination may be set for each pair of the first object and the second object in the related object association table. In addition, in a case where the importance is assigned according to the orientation of the object, the importance set in the related object association table is assigned according to the obtained angle of the orientation. For example, in a case where the angle of the orientation is smaller than the threshold, an importance of +2 is assigned to the regions of the person and the hammer by referring to the related object association table of FIG. 8. Note that the importance to be assigned may be increased as the angle of the orientation decreases.

Note that the relationship between the objects may be determined by any one of the distance between the objects, the overlap between the objects, and the orientations of the objects, or the relationship between the objects may be determined by an arbitrary combination of the distance between the objects, the overlap between the objects, and the orientations of the objects. For example, in a case where the distance between the objects is smaller than the threshold and the angle of the orientation of the object is smaller than the threshold, it may be determined that the objects are relevant. The distance and overlap between the objects, and the orientations of the objects may also be analyzed to sum the respective assigned importances.

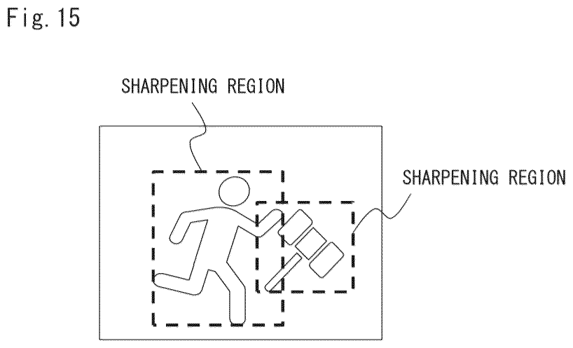

Subsequently, the terminal 100 determines the sharpening region in the input video based on the analyzed relationship between the objects (S114). The sharpening region determination unit 140 determines the sharpening region based on the presence or absence of the relationship between the objects or the importance corresponding to the relationship between the objects. In a case where it is determined that the first object and the second object are relevant, the sharpening region determination unit 140 determines the region of the first object and the region of the second object as the sharpening regions. In a case where the importance corresponding to the relationship between the first object and the second object is equal to or higher than a predetermined value, the region of the first object and the region of the second object may be determined as the sharpening regions. The sharpening region may be determined in descending order of importance assigned to the region of each object. For example, a predetermined number of regions with the highest importances are selected, and the selected regions are determined as the sharpening regions. A number of regions that can be sharpened within a range of the bit rate assigned from the compression bit rate control function 401 may be selected as the sharpening regions. In the example of FIG. 15, for example, in a case where it is determined that the person and the hammer are relevant based on the distance or overlap between the person and the hammer in the image, the rectangular region of the person and the rectangular region of the hammer are determined as the sharpening regions.

The sharpening region determination unit 140 may determine the sharpening region according to a change in the relationship between the objects. That is, the importance may be changed according to a time-series change of the distance or overlap between the objects, and the sharpening region may be determined based on the changed importance. For example, in a case where an excavator is detected around a location where soil is piled, the importance may be changed according to whether or not the excavator is moving, that is, a change in the distance or overlap between the piled soil and the excavator. In this case, there may be a case where the excavator performs root cutting work without moving in an operating state, and a case where the excavator performs backfilling work while moving in an operating state. Therefore, in a case where the excavator is moving, the region of the moving excavator may be set as the sharpening region by increasing the importance.

For example, in a case where a stepladder and the person overlapping each other are detected, the importance may be changed according to a change in the overlap between the stepladder and the person. In this example, there may be a case where the person and the stepladder greatly overlap each other such as a case where the person carries the stepladder, and a case where the person and the stepladder slightly overlap each other such as a case where the person climbs the stepladder. Since an action in which the person is standing on the stepladder is an unsafe action, the importance may be increased in a case where the overlap between the person and the stepladder is changed from a state where the person and the stepladder greatly overlap each other to a state where the person and the stepladder slightly overlap each other.

Subsequently, the terminal 100 encodes the input video based on the determined sharpening region (S115). The image quality control unit 150 encodes the input video by a predetermined video encoding method. For example, the image quality control unit 150 may encode the input video at the bit rate assigned from the compression bit rate control function 401 of the MEC 400, or may encode the input video at a bit rate corresponding to the communication quality between the terminal 100 and the center server 200. The image quality control unit 150 encodes the input video such that the sharpening region has a higher image quality than those of other regions in a range of the bit rate corresponding to the assigned bit rate or communication quality. In the example of FIG. 15, the compression rates of the rectangular region of the person and the rectangular region of the hammer are lowered to be lower than the compression rates of other regions, thereby improving the image qualities of the rectangular region of the person and the rectangular region of the hammer.

Subsequently, the terminal 100 transmits the encoded data to the center server 200 (S116), and the center server 200 receives the encoded data (S117).

The video distribution unit 160 transmits the encoded data obtained by encoding the input video to the base station 300. The base station 300 transfers the received encoded data to the center server 200 via the core network or the Internet. The video reception unit 210 receives the transferred encoded data from the base station 300.

Subsequently, the center server 200 decodes the received encoded data (S118). The decoder 220 decodes the encoded data according to the compression rate or the bit rate of each region, and generates the decoded video, that is, the reception video.

Subsequently, the center server 200 recognizes the action of the object based on the decoded reception video (S119). The action recognition unit 230 recognizes the action of the object including the person or the work object in the reception video by using the action recognition engine. The action recognition unit 230 outputs the type of the recognized action of the object. For example, as illustrated in FIG. 15, it is recognized that the action of the person is piling work from the video in which the image qualities of the rectangular region of the person and the rectangular region of the hammer are improved.

As described above, in the present example embodiment, the sharpening region is determined based on the relationship such as the positional relationship between the objects detected in the video. For example, the importance is assigned to each object region according to the positional relationship between the detected objects, and the sharpening region is determined based on the assigned importance. As a result, the sharpening region can be appropriately selected according to the situation of the object. That is, in a case where a large number of objects with high importances in sharpening appear in the video, the sharpening region can be narrowed down in order of importance. If only a predetermined object is simply sharpened by the terminal, in a case where a large number of objects to be sharpened appear in the video, all the objects that are recognition targets cannot be sharpened, and there is a possibility that the object that is the recognition target is undetected. In the present example embodiment, the terminal selects the sharpening region according to the relationship between the objects and improves the image quality of the selected region, so that the object to be recognized is preferentially sharpened. Therefore, it is possible to prevent the object that is the recognition target from being undetected.

### Second Example Embodiment

Next, a second example embodiment will be described. In the present example embodiment, an example in which a sharpening region is determined based on an object related to a situation of work will be described.

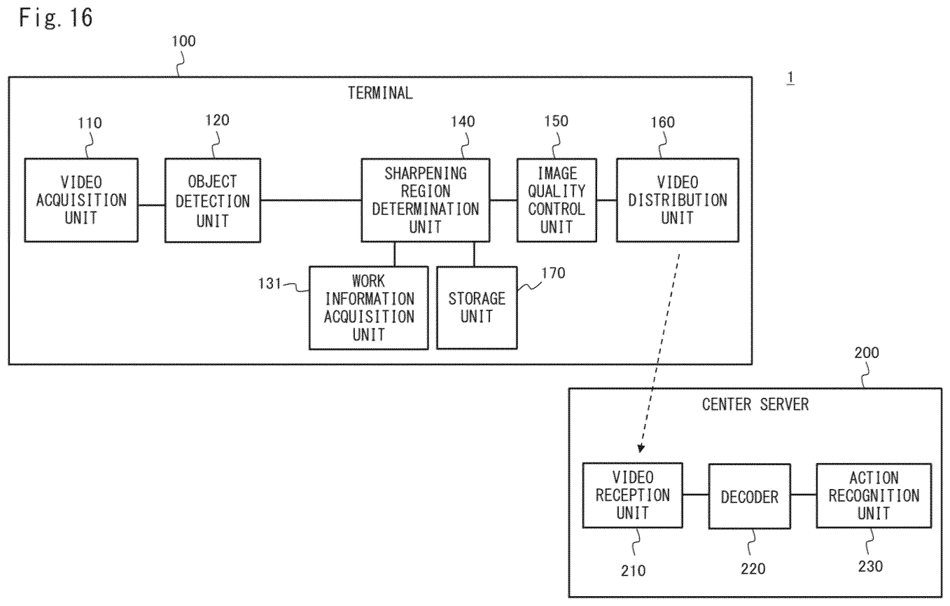

FIG. 16 illustrates a configuration example of a remote monitoring system 1 according to the present example embodiment. As illustrated in FIG. 16, in the present example embodiment, a terminal 100 includes a work information acquisition unit 131 instead of the relationship analysis unit 130 of the first example embodiment. Other configurations are similar to those in the first example embodiment. Here, a configuration different from that of the first example embodiment will be mainly described.

The work information acquisition unit 131 acquires work information indicating the situation of the work performed in a site. The work information may be information for specifying a work content of the currently performed work, or may be schedule information including a date and time when each work process is performed. The work information may be input by a worker or may be acquired from a management apparatus that manages the work process.

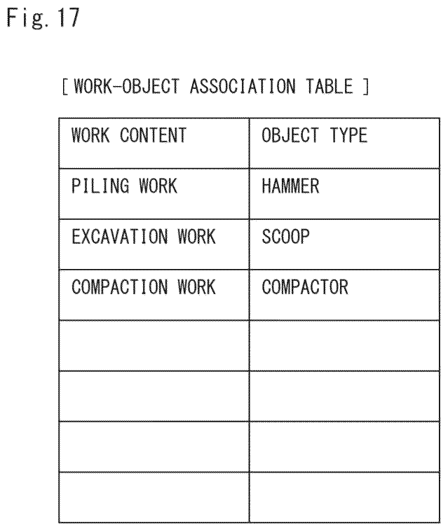

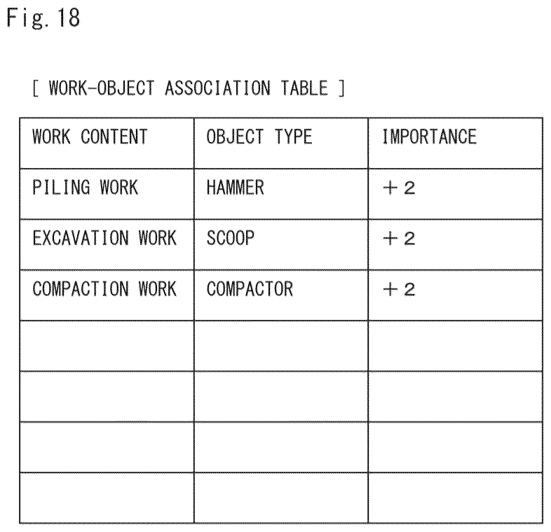

In the present example embodiment, a storage unit 170 stores a work-object association table in which the work content is associated with the object used in the work, that is, a work object. FIG. 17 illustrates an example of the work-object association table. As illustrated in FIG. 17, in the work-object association table, the work content or the work process is associated with a type of the object used in the work. In this example, a hammer used in piling work is associated with the piling work, a scoop used in excavation work is associated with excavation work, and a compactor used in compaction work is associated with the compaction work. The object is not limited to a tool related to the work, and may be a construction machine related to the work. For example, an excavator may be associated with the excavation work, or a mixer vehicle may be associated with concrete work. In FIG. 17, one work object is associated with one work, and a plurality of work objects may be associated with one work. FIG. 18 illustrates another example of the work-object association table. As illustrated in FIG. 18, in the work-object association table, an importance may be associated with the object corresponding to each work, similarly to the first example embodiment. In a case where a plurality of work objects is associated with one work, different importances may be assigned to the respective work objects.

A sharpening region determination unit 140 determines the sharpening region in an input video based on the work information acquired by the work information acquisition unit 131. The sharpening region determination unit 140 specifies the current work from the input current work content and schedule information of the work process. For example, in a case where the schedule information defines the work on X month Y day in the morning as the compaction work, if the current date and time is X month Y day in the morning, it is determined that the current work is the compaction work. The sharpening region determination unit 140 specifies the work object corresponding to the current work by referring to the work-object association table in the storage unit 170. The sharpening region determination unit 140 extracts the object having a type of the work object corresponding to the work from among the detected objects detected in the input video, and determines a rectangular region of the extracted object as the sharpening region. In the example of the work-object association table of FIG. 17, in a case where the current work is the compaction work, a region of the compactor associated with the compaction work is determined as the sharpening region.

In a case where the importance is set for each work object in the work-object association table, the sharpening region determination unit 140 assigns the importance to the extracted object based on the setting of the work-object association table, and determines the sharpening region based on the assigned importance. In the example of the work-object association table of FIG. 18, in a case where the current work is the compaction work, an importance of +2 is assigned to the region of the compactor associated with the compaction work, and the sharpening region is determined based on the assigned importance. Note that the description of units that operate as in FIG. 6 in the first example embodiment is omitted.

As described above, in the present example embodiment, the sharpening region is determined based on the work in the captured video. For example, an association between the work and the object used in the work is set in advance, the importance is assigned to each object region detected from the video according to the current work, and the sharpening region is determined based on the assigned importance. As a result, the sharpening region can be appropriately selected according to the situation of the work in the site. Also in the present example embodiment, it is possible to narrow down the sharpening region and sharpen a region with a high importance, similarly to the first example embodiment.

### Third Example Embodiment

Next, a third example embodiment will be described. In the present example embodiment, an example of determining a sharpening region by combining the first example embodiment and the second example embodiment will be described.

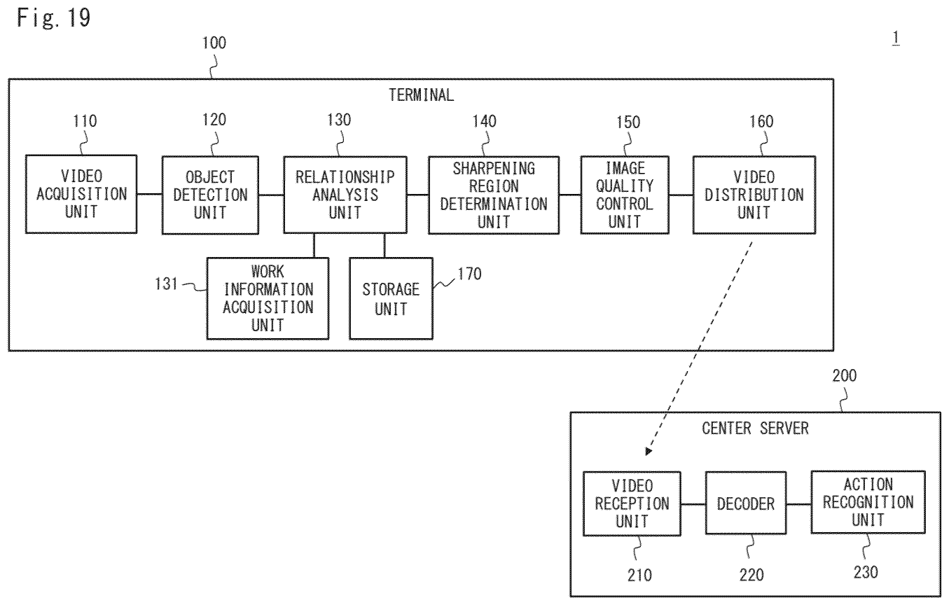

FIG. 19 illustrates a configuration example of a remote monitoring system 1 according to the present example embodiment. As illustrated in FIG. 19, in the present example embodiment, a terminal 100 includes the work information acquisition unit 131 of the second example embodiment in addition to the configuration of the first example embodiment. Other configurations are similar to those in the first and second example embodiments. Here, a configuration different from those of the first and second example embodiments will be mainly described.

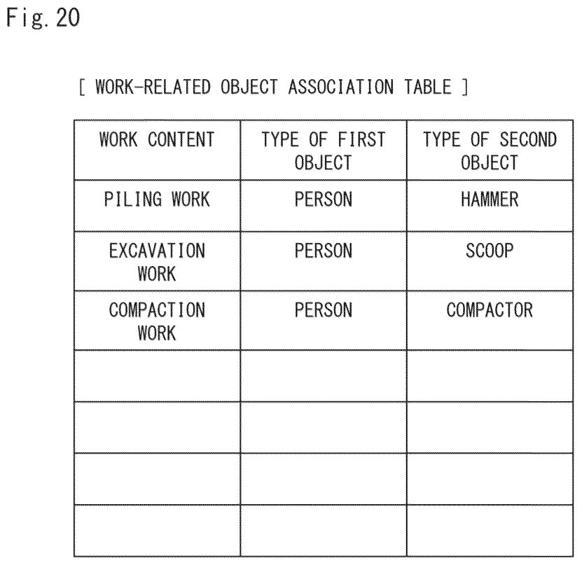

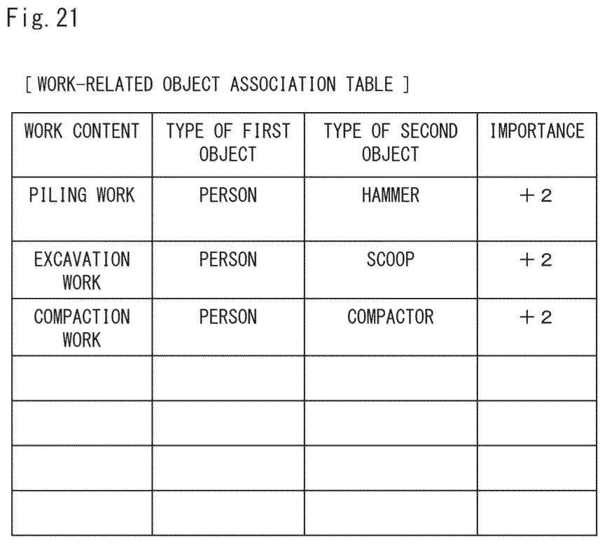

In the present example embodiment, a storage unit 170 stores a work-related object association table in which a pair of related objects whose relationship is to be analyzed is associated with a work content. FIG. 20 illustrates an example of the work-related object association table. As illustrated in FIG. 20, in the work-related object association table, the work content or a work process is associated with a type of a first object and a type of a second object. For example, one of the first object and the second object is a person, and the other is a work object. Similarly to the first example embodiment, the first object and the second object may be used as the work objects. In this example, a person who performs piling work and a hammer used in the piling work are associated with each other, a person who performs excavation work and a scoop used in the excavation work are associated with each other, and a person who performs compaction work and a compactor used in the compaction work are associated with each other. FIG. 21 illustrates another example of the work-related object association table. As illustrated in FIG. 21, in the work-related object association table, an importance may be associated with the pair of related objects corresponding to each work, similarly to the first and second example embodiments.

A relationship analysis unit 130 analyzes the relationship between the objects based on work information acquired by the work information acquisition unit 131. Similarly to the second example embodiment, the relationship analysis unit 130 specifies the current work from the input current work content and schedule information of the work process. The relationship analysis unit 130 specifies the type of the first object and the second type corresponding to the current work by referring to the work-related object association table in the storage unit 170. Similarly to the first example embodiment, the relationship analysis unit 130 extracts the first object and the second object having the type of the first object and the type of the second object from the detected objects detected in an input video, and analyzes the relationship between the extracted first object and second object. In the example of the work-object association table of FIG. 20, in a case where the current work is the piling work, a distance between the person and the hammer associated with the piling work is analyzed. For example, in a case where the distance between the person and the hammer is smaller than a predetermined threshold, it is determined that the person and the hammer are relevant.

In addition, in a case where the importance is set for each work object in the work-related object association table, the relationship analysis unit 130 assigns the importance to the extracted object based on the setting of the work-object association table. In the example of the work-object association table of FIG. 21, in a case where the current work is the piling work, the distance between the person and the hammer associated with the piling work is analyzed. For example, in a case where the distance between the person and the hammer is smaller than the predetermined threshold, an importance of +2 is assigned to regions of the person and the hammer. Note that the description of units that operate as in FIG. 6 of the first example embodiment and FIG. 16 of the second example embodiment is omitted.

As described above, the sharpening region may be determined by combining the first example embodiment and the second example embodiment. That is, a combination of the objects related to the work process is defined in advance, and the sharpening region is determined based on the relationship such as a positional relationship between the objects detected from the video according to the current work. As a result, the sharpening region can be more appropriately selected according to a situation of the work in a site and a situation of the object. Also in the present example embodiment, it is possible to narrow down the sharpening region and sharpen a region with a high importance, similarly to the first and second example embodiments.

### Fourth Example Embodiment

Next, a fourth example embodiment will be described. In the present example embodiment, an example in which a frame rate is controlled instead of an image quality in the configurations of the first to third example embodiments will be described.

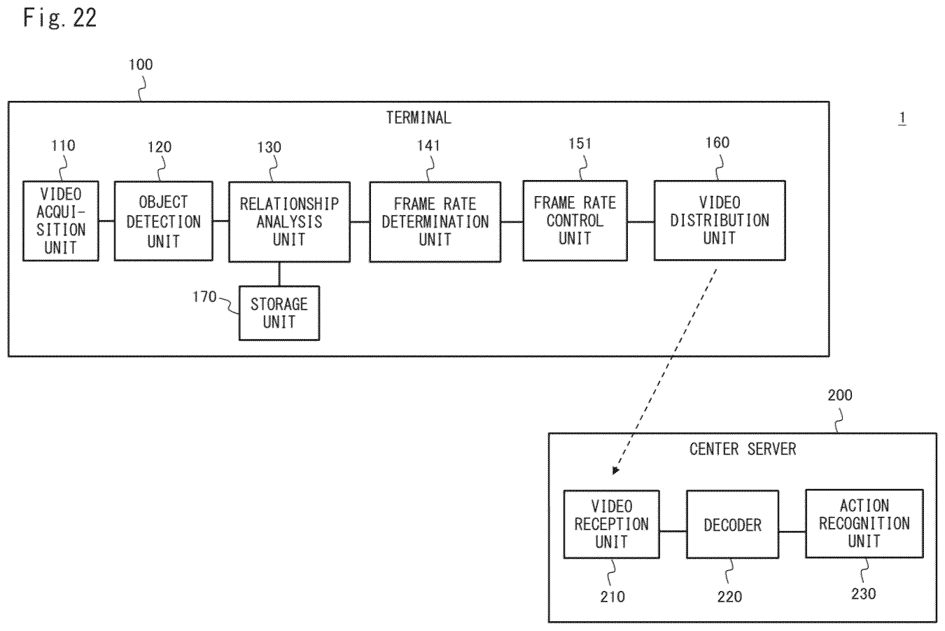

FIG. 22 illustrates a configuration example of a remote monitoring system 1 according to the present example embodiment. Note that an example in which the present example embodiment is applied to the first example embodiment will be described as an example, but the present example embodiment may be similarly applied to the second and third example embodiments. As illustrated in FIG. 22, in the present example embodiment, a terminal 100 includes a frame rate determination unit 141 instead of the sharpening region determination unit 140, and includes a frame rate control unit 151 instead of the image quality control unit 150 in the configuration of the first example embodiment. Other configurations are similar to those in the first example embodiment. Here, a configuration different from that of the first example embodiment will be mainly described.

The frame rate determination unit 141 determines a higher frame rate region in which the frame rate is increased in an input video. A method of determining the higher frame rate region is similar to that in the first example embodiment. That is, the frame rate determination unit 141 determines the higher frame rate region based on a relationship between objects analyzed by a relationship analysis unit 130. For example, the frame rate determination unit 141 may determine regions of a first object and a second object determined to be relevant as the higher frame rate regions. Furthermore, the frame rate determination unit 141 may determine the higher frame rate region according to an assigned importance of the object.

The frame rate control unit 151 controls the frame rate of the input video based on the determined higher frame rate region. Similarly to the first example embodiment, the frame rate control unit 151 is an encoder that encodes the input video by a predetermined encoding method. The frame rate control unit 151 performs encoding such that the frame rate of the higher frame rate region is higher than those of other regions. Note that encoding may be performed at a frame rate corresponding to the importance of each region.

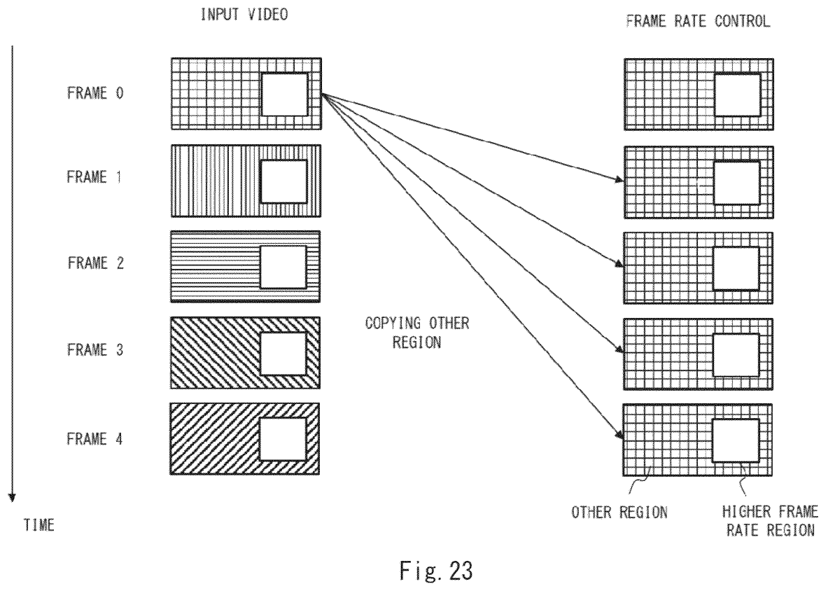

The frame rate control unit 151 may perform control such that the frame rates of other regions are substantially lower than that of the higher frame rate region. For example, as illustrated in FIG. 23, an image of another region having a low frame rate is copied to another frame. Since there is no difference between the frames of the copied region, the frame rates of other regions can be substantially lowered in encoded data. In the example of FIG. 23, by copying an image of another region of a frame 0 to frames 1 to 4, the frame rate of the another region can be made lower than that of the higher frame rate region by 1/5. Note that the description of units that operate as in FIG. 6 in the first example embodiment is omitted.

As described above, in the configurations of the first to third example embodiments, the frame rate may be controlled as a quality of the video. The higher frame rate region may be determined based on the relationship such as a positional relationship between the objects detected in the video, or the higher frame rate region may be determined based on a work process. As a result, the higher frame rate region can be appropriately selected according to a situation of the object and a situation of work. Therefore, similarly to the first to third example embodiments, it is possible to narrow down a region in which the quality is to be improved and to improve a quality of a region with a high importance.

Note that the present disclosure is not limited to the above-described example embodiments, and can be appropriately modified without departing from the scope.

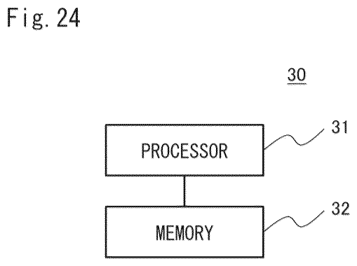

Each configuration in the above-described example embodiments may be implemented by hardware, software, or both, and may be implemented by one piece of hardware or software or by a plurality of pieces of hardware or software. The apparatuses and functions (processing) may be realized by a computer 30 including a processor 31, such as a central processing unit (CPU), and a memory 32, which is a storage device, as illustrated in FIG. 24. For example, programs for performing the methods (video processing methods) in the example embodiments may be stored in the memory 32, and the functions may be realized by the processor 31 executing the programs stored in the memory 32.

These programs include a group of commands (or software codes) causing a computer to perform one or more of the functions described in the example embodiments in a case of being read by the computer. The program may be stored in a non-transitory computer-readable medium or a tangible storage medium. As an example and not by way of limitation, the computer-readable medium or the tangible storage medium includes a random-access memory (RAM), a read-only memory (ROM), a flash memory, a solid-state drive (SSD) or any other memory technology, a CD-ROM, a digital versatile disc (DVD), a Blu-ray (registered trademark) disc or any other optical disc storage, a magnetic cassette, a magnetic tape, and a magnetic disk storage or any other magnetic storage device. The program may be transmitted on a transitory computer-readable medium or a communication medium. As an example and not by way of limitation, transitory computer-readable or communication media include electrical, optical, acoustic, or other forms of propagated signals.

Although the present disclosure has been described above with reference to the example embodiments, the present disclosure is not limited to the above-described example embodiments. Various modifications that can be understood by those skilled in the art can be made to the configurations and details of the present disclosure within the scope of the present disclosure.

Some or all of the above-described example embodiments may be described as in the following Supplementary Notes, but are not limited to the following Supplementary Notes.

### Supplementary Note 1

A video processing system including:
object detection means for detecting an object included in an input video; and
video quality control means for controlling a video quality of a region including the object in the video according to a situation related to the detected object.

### Supplementary Note 2

The video processing system according to Supplementary Note 1, in which
the situation related to the object includes a positional relationship between a first object and a second object that are the detected objects, and
the video quality control means controls the video quality of the region including the first object and the second object according to the positional relationship.

### Supplementary Note 3

The video processing system according to Supplementary Note 2, in which the positional relationship includes a distance between the first object and the second object.

### Supplementary Note 4

The video processing system according to Supplementary Note 2, in which the positional relationship includes an overlap between a region related to detection of the first object and a region related to detection of the second object.

### Supplementary Note 5

The video processing system according to any one of Supplementary Notes 2 to 4, in which the video quality control means controls the video quality of the region including the first object and the second object according to a change in the positional relationship.

### Supplementary Note 6

The video processing system according to any one of Supplementary Notes 1 to 5, in which
the situation related to the object includes a situation of work performed using a work object, and
the video quality control means controls the video quality of the region including the detected object according to whether or not the detected object is the work object corresponding to the situation of the work.

### Supplementary Note 7

The video processing system according to any one of Supplementary Notes 1 to 6, in which the video quality control means controls the video quality of the region including the object based on an importance corresponding to the situation related to the object.

### Supplementary Note 8

A video processing apparatus including:
object detection means for detecting an object included in an input video; and
video quality control means for controlling a video quality of a region including the object in the video according to a situation related to the detected object.

### Supplementary Note 9

The video processing apparatus according to Supplementary Note 8, in which
the situation related to the object includes a positional relationship between a first object and a second object that are the detected objects, and
the video quality control means controls the video quality of the region including the first object and the second object according to the positional relationship.

### Supplementary Note 10

The video processing apparatus according to Supplementary Note 9, in which the positional relationship includes a distance between the first object and the second object.

### Supplementary Note 11

The video processing apparatus according to Supplementary Note 9, in which the positional relationship includes an overlap between a region related to detection of the first object and a region related to detection of the second object.

### Supplementary Note 12

The video processing apparatus according to any one of Supplementary Notes 9 to 11, in which the video quality control means controls the video quality of the region including the first object and the second object according to a change in the positional relationship.

### Supplementary Note 13

The video processing apparatus according to any one of Supplementary Notes 8 to 12, in which
the situation related to the object includes a situation of work performed using a work object, and
the video quality control means controls the video quality of the region including the detected object according to whether or not the detected object is the work object corresponding to the situation of the work.

### Supplementary Note 14

The video processing apparatus according to any one of Supplementary Notes 8 to 13, in which the video quality control means controls the video quality of the region including the object based on an importance corresponding to the situation related to the object.

### Supplementary Note 15

A video processing method including:
detecting an object included in an input video; and
controlling a video quality of a region including the object in the video according to a situation related to the detected object.

### Supplementary Note 16

The video processing method according to Supplementary Note 15, in which
the situation related to the object includes a positional relationship between a first object and a second object that are the detected objects, and
the video quality of the region including the first object and the second object is controlled according to the positional relationship.

### Supplementary Note 17

The video processing method according to Supplementary Note 16, in which the positional relationship includes a distance between the first object and the second object.

### Supplementary Note 18

The video processing method according to Supplementary Note 16, in which the positional relationship includes an overlap between a region related to detection of the first object and a region related to detection of the second object.

### Supplementary Note 19

The video processing method according to any one of Supplementary Notes 16 to 18, in which the video quality of the region including the first object and the second object is controlled according to a change in the positional relationship.

### Supplementary Note 20

The video processing method according to any one of Supplementary Notes 15 to 19, in which
the situation related to the object includes a situation of work performed using a work object, and
the video quality of the region including the detected object is controlled according to whether or not the detected object is the work object corresponding to the situation of the work.

### Supplementary Note 21

The video processing method according to any one of Supplementary Notes 15 to 20, in which the video quality of the region including the object is controlled based on an importance corresponding to the situation related to the object.

### Supplementary Note 22

A video processing program for causing a computer to execute processing of:
detecting an object included in an input video; and
controlling a video quality of a region including the object in the video according to a situation related to the detected object.

### REFERENCE SIGNS LIST

1 REMOTE MONITORING SYSTEM
10 VIDEO PROCESSING SYSTEM
11 OBJECT DETECTION UNIT
12 VIDEO QUALITY CONTROL UNIT
20 VIDEO PROCESSING APPARATUS
30 COMPUTER
31 PROCESSOR
32 MEMORY
100 TERMINAL
101 CAMERA
102 COMPRESSION EFFICIENCY OPTIMIZATION FUNCTION
120 OBJECT DETECTION UNIT
130 RELATIONSHIP ANALYSIS UNIT
131 WORK INFORMATION ACQUISITION UNIT
140 SHARPENING REGION DETERMINATION UNIT
141 FRAME RATE DETERMINATION UNIT
150 IMAGE QUALITY CONTROL UNIT
151 FRAME RATE CONTROL UNIT
160 VIDEO DISTRIBUTION UNIT
170 STORAGE UNIT
200 CENTER SERVER
201 VIDEO RECOGNITION FUNCTION
202 ALERT GENERATION FUNCTION
203 GUI DRAWING FUNCTION
204 SCREEN DISPLAY FUNCTION
210 VIDEO RECEPTION UNIT
220 DECODER
230 ACTION RECOGNITION UNIT
300 BASE STATION
400 MEC
401 COMPRESSION BIT RATE CONTROL FUNCTION

What is claimed is:

1. A video processing system comprising:
a memory configured to store instructions, and
a processor configured to execute the instructions to;
detect an object included in an input video; and
control a video quality of a region including the object in the video according to a situation related to the detected object.

2. The video processing system according to claim 1, wherein
the situation related to the object includes a positional relationship between a first object and a second object that are the detected objects, and
the processor is further configured to execute the instructions to control the video quality of the region including the first object and the second object according to the positional relationship.

3. The video processing system according to claim 2, wherein the positional relationship includes a distance between the first object and the second object.

4. The video processing system according to claim 2, wherein the positional relationship includes an overlap between a region related to detection of the first object and a region related to detection of the second object.

5. The video processing system according to claim 2, wherein the processor is further configured to execute the instructions to control the video quality of the region including the first object and the second object according to a change in the positional relationship.

6. The video processing system according to claim 1, wherein
the situation related to the object includes a situation of work performed using a work object, and
the processor is further configured to execute the instructions to control the video quality of the region including the detected object according to whether or not the detected object is the work object corresponding to the situation of the work.

7. The video processing system according to claim 1, wherein the processor is further configured to execute the instructions to control the video quality of the region including the object based on an importance corresponding to the situation related to the object.

8. A video processing apparatus comprising:
a memory configured to store instructions, and
a processor configured to execute the instructions to;
detect an object included in an input video; and
control a video quality of a region including the object in the video according to a situation related to the detected object.

9. The video processing apparatus according to claim 8, wherein the situation related to the object includes a positional relationship between a first object and a second object that are the detected objects, and
the processor is further configured to execute the instructions to control the video quality of the region including the first object and the second object according to the positional relationship.

10. The video processing apparatus according to claim 9, wherein the positional relationship includes a distance between the first object and the second object.

11. The video processing apparatus according to claim 9, wherein the positional relationship includes an overlap between a region related to detection of the first object and a region related to detection of the second object.

12. The video processing apparatus according to claim 9, wherein the processor is further configured to execute the instructions to control the video quality of the region including the first object and the second object according to a change in the positional relationship.

13. The video processing apparatus according to claim 8, wherein
the situation related to the object includes a situation of work performed using a work object, and
the processor is further configured to execute the instructions to control the video quality of the region including the detected object according to whether or not the detected object is the work object corresponding to the situation of the work.

14. The video processing apparatus according to claim 8, wherein the processor is further configured to execute the instructions to quality control means controls control the video quality of the region including the object based on an importance corresponding to the situation related to the object.

15. A video processing method comprising:
detecting an object included in an input video; and
controlling a video quality of a region including the object in the video according to a situation related to the detected object.

16. The video processing method according to claim 15, wherein
the situation related to the object includes a positional relationship between a first object and a second object that are the detected objects, and
the video quality of the region including the first object and the second object is controlled according to the positional relationship.

17. The video processing method according to claim 16, wherein the positional relationship includes a distance between the first object and the second object.

18. The video processing method according to claim 16, wherein the positional relationship includes an overlap between a region related to detection of the first object and a region related to detection of the second object.

19. The video processing method according to claim 16, wherein the video quality of the region including the first object and the second object is controlled according to a change in the positional relationship.

20. The video processing method according to claim 15, wherein
the situation related to the object includes a situation of work performed using a work object, and
the video quality of the region including the detected object is controlled according to whether or not the detected object is the work object corresponding to the situation of the work.

21. (canceled)
